(19) United States
(12) Patent Application Publication
(10) Pub. No.: US 2026/0202800 A1
(43) Pub. Date: Jul. 16, 2026

(54) OXYGEN-RESPONSIVE EXPIRATION DATE INDICATOR

(71) Applicants: Masatsugu KAWANISHI, Chiba Pref. (JP); Rikuto KOMURA, Tokyo (JP); Mika ONOZAWA, Tokyo (JP); Haruto KUGA, Chiba Pref. (JP); Seiran KIKUCHI, Tokyo (JP); Sakurako FUJII, Saitama Pref. (JP); Nobu YAMAZAKI, Nagano Pref. (JP)

(72) Inventors: Masatsugu KAWANISHI, Chiba Pref. (JP); Rikuto KOMURA, Tokyo (JP); Mika ONOZAWA, Tokyo (JP); Haruto KUGA, Chiba Pref. (JP); Seiran KIKUCHI, Tokyo (JP); Sakurako FUJII, Saitama Pref. (JP); Nobu YAMAZAKI, Nagano Pref. (JP)

(21) Appl. No.: 19/560,191

(22) Filed: Mar. 9, 2026

(51) Int. Cl. G04F 13/02; B32B 7/06; B32B 7/12; B32B 27/08; B32B 27/32; B32B 27/36

(52) U.S. Cl. CPC G04F 13/02; B32B 7/06; B32B 7/12; B32B 27/08; B32B 27/32; B32B 27/36; B32B 2307/402; B32B 2307/7244; B32B 2439/70

(57) ABSTRACT

An expiration date indicator includes a first protective sheet that prevents oxygen intrusion, an oxygen transmission film disposed beneath the first protective sheet, wherein the oxygen transmission film is composed of a plurality of separable layers, a reaction layer disposed beneath the oxygen transmission film, wherein the reaction layer reacts with oxygen and changes color, a support layer disposed beneath the reaction layer, wherein the support layer is formed of an adhesive material, and a second protective sheet disposed beneath the support layer and preventing deterioration of the support layer.

### FIELD OF THE INVENTION

The present invention relates to an indicator for visually displaying the passage of time, and more particularly to an indicator that initiates operation by peeling off a protective sheet (seal), is less susceptible to ambient temperature or humidity, and changes color only in response to oxygen.

### BACKGROUND OF THE INVENTION

In related art, various visual indicators have been developed for quality maintenance and freshness management of food products, pharmaceuticals, and the like. Representative examples include the time-temperature indicator provided by Timestrip™ and Fresh-Check™ provided by Zebra Technologies.

As disclosed in U.S. Pat. No. 7,232,253B2, the Timestrip™ indicator operates in a format in which a user presses a button to mix the internal chemicals, thereby initiating the reaction. The structure of this indicator includes a three-layer structure having a button containing a liquid, a passage layer for this liquid, and a reaction groove that changes color when contacted by the liquid. In this type of indicator, when the button is pressed, the container in which the liquid is stored ruptures. In the passage layer, the liquid begins to move by capillary action, and reaches the reaction groove eventually. Thereby, the liquid changes the color of the groove. Therefore, this type of indicator utilizes the movement speed of the liquid to produce color changes over time. Thus, it is an indicator that enables time measurement by changing the structure of the passage layer to alter the movement speed of the liquid. Additionally, Timestrip™ is an indicator using a similar structure and principle, but changes the measurement time by varying the liquid used and the material and thickness of the passage layer. However, this structure has two constraints. The first is structural constraint. This type of indicator has the risk of accidentally pressing the button, which may cause unintended operation. And the second is that the user cannot change the measurement time of the indicator, according to the situation. With this structure, only one type of time can be measured per indicator. Specifically, the measurement time varies depending on the type of liquid existing in the button of the internal structure and the structure of the passage layer. Therefore, since the type of liquid and the structure of the passage layer are determined at the time of manufacture, the measurement time by the indicator is fixed at the time of manufacture. Consequently, as mentioned above, the user cannot change the measurement time at the time of use.

On the other hand, as disclosed in U.S. Patent Application Publication No. 2007/0067177A1, Zebra Technologies'Fresh-Check™ indicates temperature changes of the indicator using a substance that changes color with temperature, specifically mainly polydiacetylene-based active agents. The structure is that of a seal coated with polydiacetylene-based active agents. Specifically, the seal coated with polydiacetylene-based active agents reacts according to any temperature within about −20 degree Celsius to about 60 degree Celsius, and the polydiacetylene-based active agent reacts to temperature and causes color change. These color changes make it possible to recognize in which temperature range the object has been placed. This makes it an indicator that visualizes whether the object has been placed outside the recommended temperature when the object has potentially been placed outside the recommended temperature. Therefore, when this type of indicator is placed in a package containing fresh food products, it can be used as an indicator of whether the fresh food products have been placed outside the recommended temperature. However, this type of indicator can recognize whether it has been exposed to a specific temperature, but cannot recognize for how long it has been exposed to that temperature.

Under such circumstances, there is a demand for a new type of indicator for time measurement that has no risk of malfunction due to buttons or the like, enables the user to start measurement at an intended timing, allows specification of the measurement time, is less susceptible to the influence of environmental factors such as temperature and humidity, and measures time by responding only to oxygen, which is a relatively stable external factor.

### SUMMARY OF THE INVENTION

The object of the present invention is to provide an indicator that solves the above problems. In order to achieve this object, an expiration date indicator includes a first protective sheet that prevents oxygen intrusion, an oxygen transmission film disposed beneath the first protective sheet, wherein the oxygen transmission film is composed of a plurality of separable layers, a reaction layer disposed beneath the oxygen transmission film, wherein the reaction layer reacts with oxygen and changes color, a support layer disposed beneath the reaction layer, wherein the support layer is formed of an adhesive material, and a second protective sheet disposed beneath the support layer and preventing deterioration of the support layer.

### BRIEF DESCRIPTION OF THE DRAWINGS

This invention will be more particularly described with reference to the accompanying drawings, in which:

FIG. 1 is a cross-sectional view of an indicator, according to the present invention.

### DETAILED DESCRIPTION OF THE PREFERRED EMBODIMENT

The preferred embodiment of this invention as to an indicator is explained together with drawings as follows. In each drawing, the same reference numbers designate the same or similar components through all embodiments.

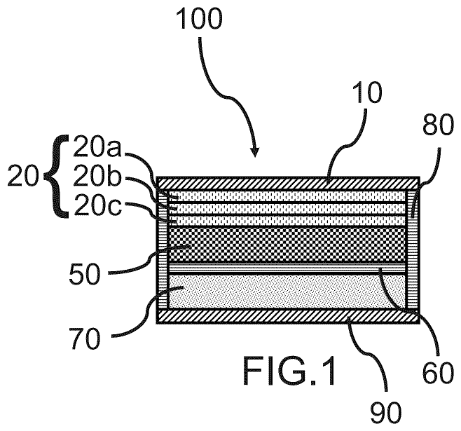

As shown in FIG. 1, the indicator 100 of the present invention includes a first protective sheet 10 that prevents oxygen intrusion, a film 20 having a three-layer structure that restricts the oxygen transmission rate, a reaction layer 50 that changes color by reacting with oxygen, a first oxygen barrier layer 60 that blocks air and prevents oxidation of the reaction layer 50, and a support layer 70 that is an adhesive base, which are sequentially laminated on a second protective sheet 90. Furthermore, a second oxygen barrier layer 80 formed of the same material as the first protective sheet 10 is formed on side surfaces of the indicator 100 to prevent oxygen from entering the reaction layer 50 from the side surfaces.

The first protective sheet 10 is an oxygen-impermeable film having an adhesive layer on one surface. The oxygen-impermeable film is formed of, for example, polyethylene terephthalate (PET) or polypropylene (PP), and the adhesive layer is formed of a polyacrylate-based or rubber-based adhesive. The first protective sheet 10 is formed on the film 20 with the adhesive layer contacting the film 20. The first protective sheet 10 can be peeled off from the film 20 independently, and when the first protective sheet 10 is peeled off, the surface of the film 20 is exposed. As described above, this film 20 having a three-layer structure as shown in FIG. 1 includes a first layer 20a, a second layer 20b, and a third layer 20c, wherein the first layer to the third layer 20a, 20b, 20c are all formed of the same material and the same thickness. Therefore, since the film 20 is divided into layers from the first layer to the third layer 20a, 20b, 20c, it is possible to peel off each layer individually or to peel multiple layers off at once. Since the film 20 works to restrict the oxygen transmission rate, the more layers are peeled off, the greater the oxygen transmission rate becomes, so oxygen reaches the reaction layer 50 formed directly beneath the film 20 in a short time.

The adhesive of the support layer 70 is formed of a polyacrylate-based or rubber-based adhesive. The film 20 is made of a polymeric material having gas barrier properties, and polyethylene (PE), polypropylene (PP), or the like is used.

This film 20 is exposed when the first protective sheet 10 is peeled off, and as oxygen gradually permeates through this film 20, oxygen is supplied to the reaction layer 50, which is the lower layer thereof.

The reaction layer 50, which changes color by reacting with oxygen, causes a chemical reaction upon contact with oxygen, producing a visual change, namely a color change. The reaction layer 50 is composed mainly of Reversible Methylene blue, which is applied to or impregnated in cellulose nanofiber. When oxygen is supplied to the reaction layer 50, the Reversible Methylene blue, which is the main component, is oxidized and changes from colorless or light blue to deep blue. This reaction rate is controlled by varying the number of remaining layers among the first layer 20a, the second layer 20b and the third layer 20c that constitute the film 20, thereby changing the thickness and, consequently, the amount of oxygen transmission.

Thus, by controlling the amount and speed of oxygen reaching the reaction layer through the thickness and configuration of the film 20 composed of multiple layers, the user can freely adjust the reaction rate, enabling stable expression of oxygen-dependent color change that is less susceptible to the influence of temperature and humidity. This allows the user to design the color development speed according to the application and clearly visualize the passage of time.

The support layer 70 is formed directly beneath this first oxygen barrier layer 60. The support layer 70 is formed of an adhesive support film that supports the entire structure. The second protective sheet 90 is formed directly beneath the support layer 70, and the second protective sheet 90 prevents deterioration of the support layer 70 by oxidation. By peeling off this second protective sheet, the support layer 70 is exposed, and the indicator 100 can be attached to a desired location by the support layer 70. The exposed surface of this support layer 70 is coated with the same adhesive as the adhesive layer of the first protective sheet 10.

The second oxygen barrier layer 80 is provided on the side surfaces of the indicator 100 and is formed for the purpose of preventing oxygen from entering the indicator 100. Therefore, it is formed of the same material as the first protective sheet 10, and can be formed by applying that material to the side surfaces of the indicator 100, whereby manufacturing simplification and consistency of adhesive performance are achieved.

The indicator of the present invention is manufactured by the following process. Initially, a polyethylene terephthalate (PET) or a polypropylene (PP) film is prepared as a support material. A polyacrylate-based or rubber-based adhesive is applied to one side of the support material and dried to form the support layer 70. Thereafter, the second protective sheet 90 is adhered to the lower part of this layer so that the adhesiveness of the support layer 70 is not lost.

Next, the reaction layer 50 is formed. The coating liquid for the reaction layer is prepared with Reversible Methylene blue as the main component, which is applied to or impregnated in cellulose nanofiber. Thereafter, the film 20 previously formed into three layers 20a, 20b, 20c is formed on the reaction layer 50. These layers are composed of polyethylene (PE), polypropylene (PP). Each layer is adhered by existing technology.

The first protective sheet 10 is disposed on the film 20. The first protective sheet 10 is the oxygen-impermeable film having an adhesive layer on one surface as described above, and the adhesive layer is adhered to the film 20 so as to cover the entirety. Furthermore, in order to prevent oxygen intrusion from the side surfaces, the second oxygen barrier layer 80 is formed.

While this invention has been described with reference to illustrative embodiments, this description is not intended to be construed in a limiting sense. Thus, shapes, size and physical relationship of each component are roughly illustrated so the scope of this invention should not be construed to be limited to them. Further, to clarify the components of this invention, hatching is partially omitted in the cross-sectional views. Moreover, the numerical description in the embodiment described above is one of the preferred examples in the preferred embodiment so that the scope of this invention should not be construed to limit to them.

Various other modifications of the illustrated embodiment will be apparent to those skilled in the art on reference to this description. Therefore, the appended claims are intended to cover any such modifications or embodiments as fall within the true scope of this invention.

What is claimed is:

1. An expiration date indicator, comprising:
a first protective sheet that prevents oxygen intrusion;
an oxygen transmission film disposed beneath the first protective sheet, wherein the oxygen transmission film is composed of a plurality of separable layers;
a reaction layer disposed beneath the oxygen transmission film, wherein the reaction layer reacts with oxygen and changes color;
a support layer disposed beneath the reaction layer, wherein the support layer is formed of an adhesive material; and
a second protective sheet disposed beneath the support layer and preventing deterioration of the support layer.

2. An expiration date indicator, according to claim 1, wherein the plurality of layers constituting the oxygen transmission film are formed of the same material and have the same thickness.

3. The An expiration date indicator according to claim 1, further comprising:
a first oxygen barrier layer disposed between the reaction layer and the support layer; and
a second oxygen barrier layer formed on side surfaces of the oxygen transmission film, the reaction layer, the support layer, and the first oxygen barrier layer.
